(19) United States
(12) Patent Application Publication
(10) Pub. No.: US 2015/0334925 A1
(43) Pub. Date: Nov. 26, 2015

(54) CONTAINER CONTAINING COMPONENTS FOR ERECTING ABOVE-GROUND PLANTERS, METHOD OF ERECTING ABOVE-GROUND PLANTERS, AND MODULAR ABOVE-GROUND PLANTERS

(71) Applicant: BARRY D. SETZER, BLOWING ROCK, NC (US)

(72) Inventor: BARRY D. SETZER, BLOWING ROCK, NC (US)

(21) Appl. No.: 14/720,904

(22) Filed: May 26, 2015

Related U.S. Application Data
(60) Provisional application No. 62/002,843, filed on May 24, 2014.

(51) Int. Cl. A01G 9/02

(52) U.S. Cl. CPC A01G 9/02; A01G 9/027

(57) ABSTRACT

A method of erecting and filling above-ground planters from components contained in the containers, which containers serve as forms for retaining the planters in the shape of the containers during filling and erecting the planters. The resulting filled planters can have flat sides so that planters can be arranged with contacting sides that allow cross rooting and arranging in multiple planters forming beds in selected configurations.

This application claims the benefit of U.S. Provisional Application Ser. No. 62/002,843, filed May 24, 2014.

### FIELD OF INVENTION

The present invention relates to above-ground planters, and more particularly to erecting and filling above-ground planters with plant growth media, wherein the empty planters and media, as well as any other desired components, are contained in individual containers.

### BACKGROUND OF THE INVENTION

Traditionally, a gardener, particularly a home gardener, purchases a planter, a spacer for supporting a planter, and plant growth media, as well as other desired components, separately, and assembles the components and erects and fills the pre-standing planters without any form for maintaining the planter in its desired shape during erecting and filling of the planter, and without any correlation of the quantity and shape of the various components.

### SUMMARY OF THE INVENTION

The present invention provides a unique method of erecting and filling above-ground planters where all of the components are originally contained in containers that also serve as forms for retaining the planters in the desired shape during filling and erecting of the planters.

Each container originally contains at least one, and preferably two, of each a folded planter, a mesh spacer, shaped to fit the bottom of the planter and on which the planter will ultimately be supported on a supporting surface, such as the ground, pavement, or floor of a building structure, and a block of compressed, dehydrated plant growth media shaped to fit in the container and having a volume when decompressed and hydrated sufficient to fill the planter or planters.

In a first preferred embodiment, the container may be a cardboard shipping container of a size for containing therein one, or preferably two, folded planters, mesh spacers, a block of compressed, dehydrated plant growth media of a quantity sufficient, when decompressed and hydrated to fill the platter or planters contained in the container, and, optionally, a block of fertilizer, and a folded liquid-impervious bag for hydrating the plant growth media.

To erect the planter or planters, the contents of the container are removed, the bottom closure flaps of the container are opened and the container is placed on a supporting surface with the bottom open and the bottom closure flaps extending outwardly on the supporting surface. A mesh spacer is placed in the open bottom of the container and the plant growth media is hydrated and decompressed in the bag separate from the container. The folded planter is unfolded and inserted into the container on top of the previously inserted mesh spacer with the top closure flaps of the container extending vertically. The planter is then filled with the hydrated plant growth media, and, optionally, the fertilizer is placed on top of the plant growth media and mixed into the media. The open container is then lifted from the filled planter, which is then supported independently on the mesh spacer and can be slid thereon to any desirable location. These steps would be repeated for each additional planter included in the container.

In an alternate form of the preferred embodiment of the present invention, the container contains an open liquid-impervious liner that extends over the bottom and along the side walls of the container and sufficiently beyond the side walls so that when the top closure flaps of the container are folded along the sides of the container the top of the liner can be folded down over the flaps to hold the container open. Contained in the container inside the liner is at least one unfolded, and preferably a second folded, planter, at least one mesh spacer, two if there are two planters, and a block or two blocks of compressed, dehydrated plant growth media, and optionally a block or two blocks of fertilizer.

In erecting and filling the planter of the alternate form of the preferred embodiment, the contents inside the unfolded planter are removed, except the liner and one block of decompressed, dehydrated plant growth media. Water is then added to hydrate and compress the plant growth media to fill the unfolded planter. The liquid-impervious liner prevents water from leaking from the planter onto the container. Optionally, a block of fertilizer can be placed on and mixed into the plant growth media. The filled planter is then removed from the container and placed on the mesh spacer. If a second planter is involved, it is unfolded and placed in the liner in the container. A second block of compressed, dehydrated plant growth media is then placed in the planter in the container and is hydrated and decompressed by adding water. Fertilizer can then be added and mixed with the plant growth media. The filled planter will then be removed from the container and placed on the other mesh spacer.

The filled planters resulting from these methods of using the container as a form will be formed with substantially straight sides such that, when two or more of the planters are placed in side contact, the root systems can extend across the contacting walls for enhanced growth. Also, the substantially straight side walls allow a plurality of side contacting planters to be arranged in selected patterns or sequences to give the appearance of a single configured bed.

### BRIEF DESCRIPTION OF THE DRAWINGS

FIG. 1 is a perspective view of a container according to the first preferred embodiment of the present invention;

FIG. 2 is a vertical sectional view of the container of FIG. 1 taken a long line 2-2 of FIG. 1;

FIGS. 3a, b, and c illustrate the steps in the method of filling a bag with plant growth media in practicing the first preferred embodiment of the method of the present invention;

FIGS. 4a-d illustrate the steps in the method of erecting a filled planter according to the first preferred embodiment of the method of the present invention;

FIG. 5 is a perspective view of a container according to the alternate preferred embodiment of the present invention;

FIG. 6 is a vertical sectional view of the container of FIG. 5 taken along line 6-6 of FIG. 5;

FIGS. 7a-e illustrate the steps in the method of erecting a filled planter according to the alternate preferred embodiment of the present invention;

FIG. 8 is a perspective view of a single planter erected according to the methods of the present invention;

FIG. 9 is a perspective view of two planters erected according to the methods of the present invention with sides in contact and illustrating the cross growth of root systems from one planter to the other; and

FIG. 10 is a perspective view of a series of side contacting planters of the present invention arranged in a zig-zag configuration as a single bed.

### DETAILED DESCRIPTION OF THE PREFERRED EMBODIMENTS OF THE PRESENT INVENTION

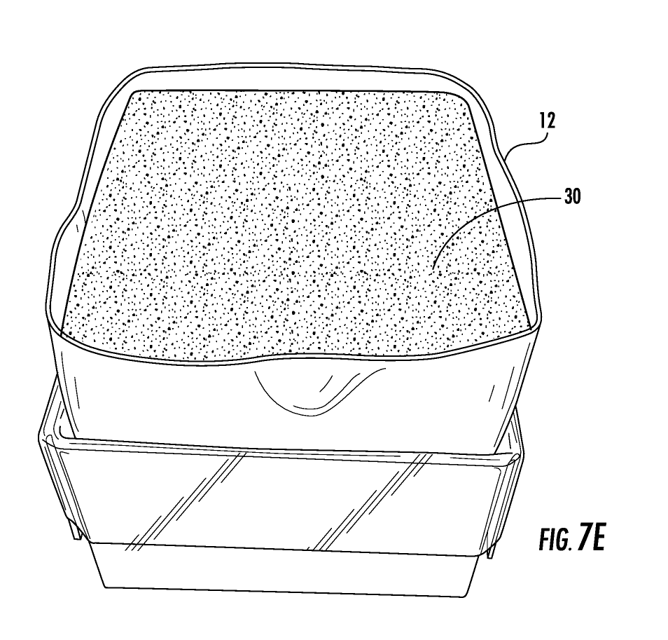

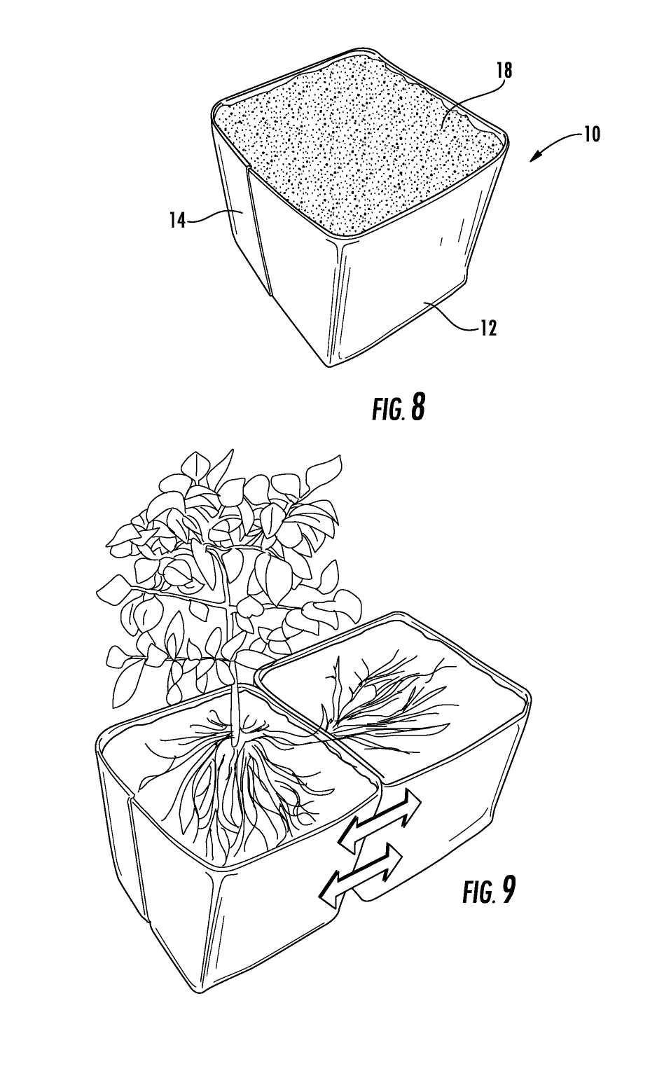

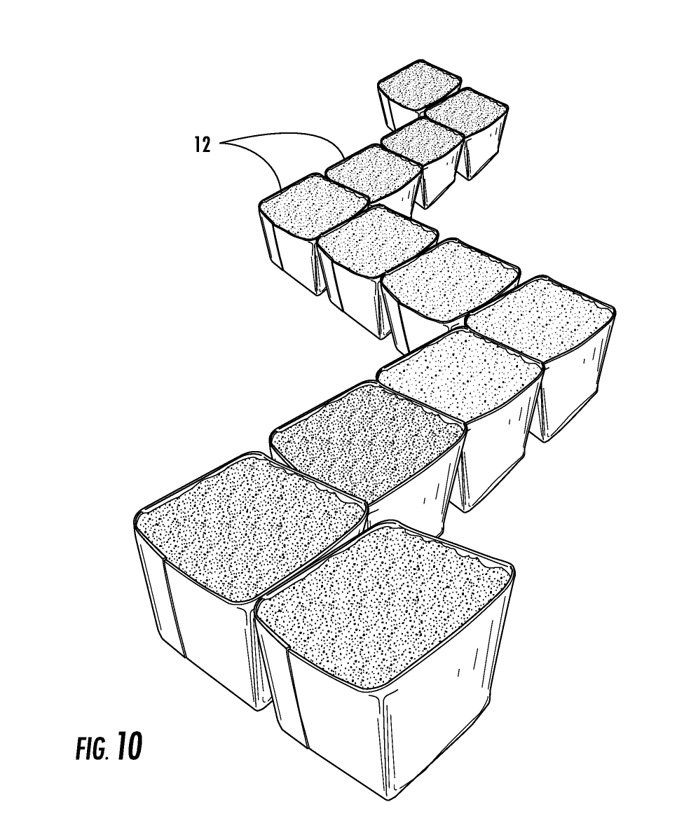

In one embodiment of the planting structures of the present invention, cubically-shaped modular above-ground planters 12 have four flat sides 14 that allow the planters to be arranged in any composite configuration with the sides of adjacent planters being contiguous (FIGS. 8 and 9). Not only does this contiguous configuration result in the appearance of a unitary bed, but, importantly, the contacting flat sides permit beneficial expansion of root systems from one modular planter to an adjacent modular planter for enhanced healthy plant growth. Preferably, the planters are supported on open mesh spacers 16 to allow air circulation to the underside of the planters for improved plant growth, to avoid moisture accumulation that could stain or damage the supporting surface, and to facilitate sliding of the structures into selected multiple plantar configurations (FIG. 10).

In the preferred embodiment, the planters 12 are made from material that is air and moisture permeable, non-woven, needle-punched, polymeric geotextile fabric, preferably a polypropylene.

The somewhat flimsy and collapsible characteristic of the folded planter is a result of the relatively lightweight and relatively inexpensive material from which the planter is made. In the preferred embodiment, the material is an air and moisture permeable, collapsible, non-woven, needle-punched, polymeric geotextile fabric. The polymeric material is preferably polypropylene. In a specific embodiment the polypropylene fabric weighs approximately 6 ounces per square yard. This 6 ounce fabric is obtained from Dalco Nonwovens, LLC bearing the product designation of G 300-BLK063-073-600, having a US sieve rating of approximately as required by ASTM D-4751, a mean air permeability of approximately (ASTM D-737), and a water flow rate of approximately 110 gallons per minute per square foot (ASTM space D 4751). One surface of these fabrics has been heat treated to provide a smooth outer surface on the planter and minimize undesirable elongation. Other suitable fabrics and fabric weights providing desired characteristics may be used other than those specifically described herein.

It has been found that a suitable shape for the planter 12 is a square cross-section, for example, a one foot square planter, which is a size that will adequately retain its shape when filled and is of a weight that can be easily lifted or slid. Also, the four sided cube shape results in the planters being modular for arranging with other planters to form a composite plant bed of any desired configuration.

The open mesh spacers 16 may be formed from a matrix of extruded melted synthetic polymer material, such as polypropylene, or other similar polymers, such as nylon, that has been extruded randomly onto a die to create open spaces for air circulation and water drainage. In one embodiment, molten polymer is dribbled as filaments over a form in an irregular pattern with filaments fixed to each other at their crossings to form an open three-dimensional structure that is approximately 90% to 95% voids. A suitable product is Enkamat 3040 marketed by Bonar, Inc. of Enka, N.C. Other suitable materials can be used as well.

The planters 12 may be filled with a plant growth media 18, such as coir pith material derived from the inner layers of coconut husks.

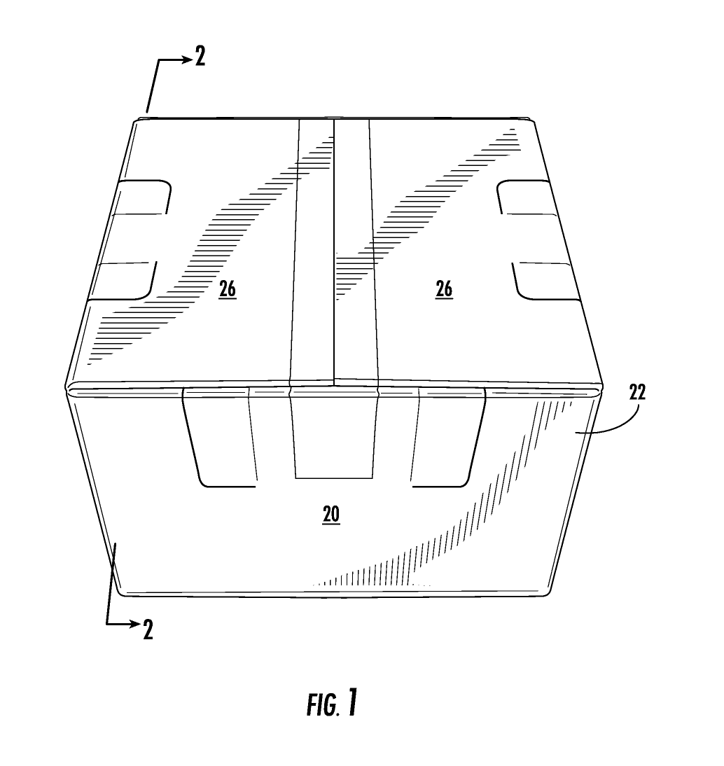

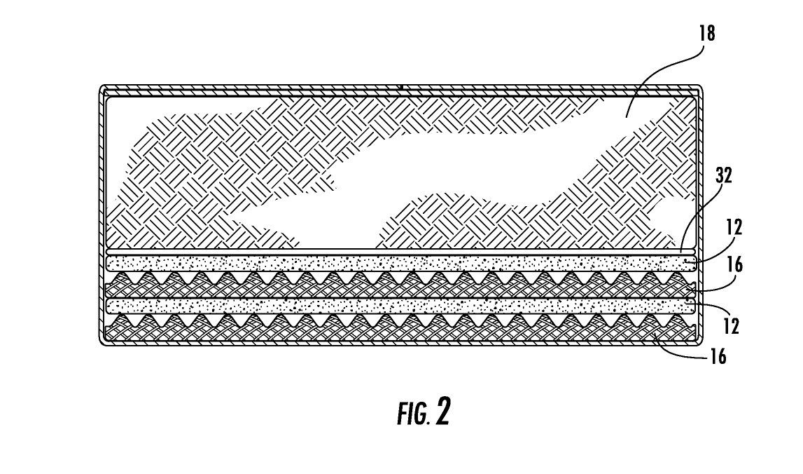

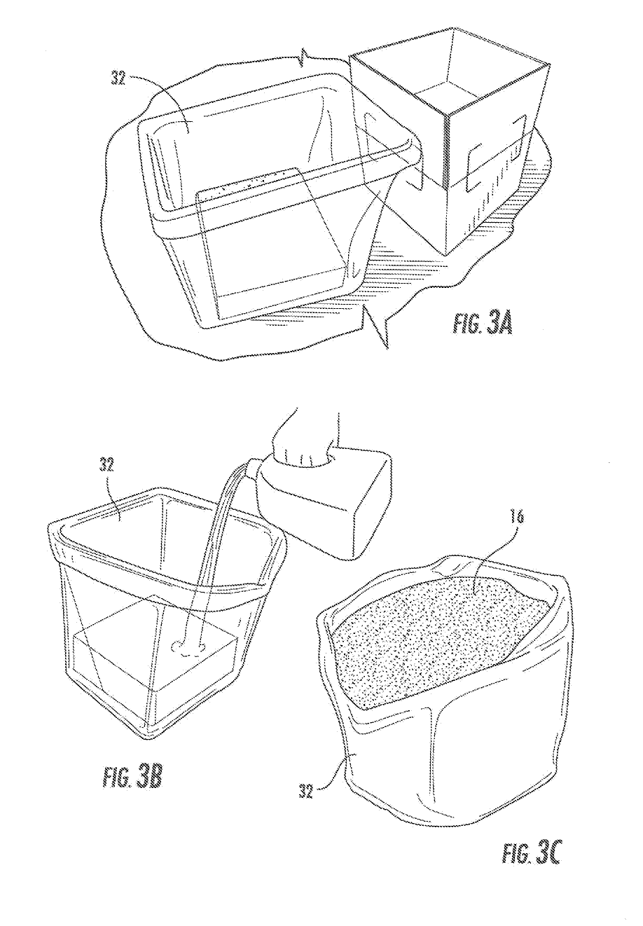

In a first preferred embodiment of the container 20 of the present invention, illustrated in FIGS. 1 and 2, the container 20 is in the form of a cardboard shipping or storage box 22 that has four sidewalls 24, four interlocking top closure flaps 26, and four interlocking bottom closure flaps 28. The container 20 contains two of the mesh spacers 16 described above of the same footprint dimensions as the inside of the bottom of the container, two folded planters 12 of known flexible air and moisture permeable material having the same footprint dimensions as the inside of the box 22, and a block 30 of compressed, dehydrated plant growing media 18 of a quantity sufficient to fill two planters when hydrated.

The planter 12 is made of the same material described above. Other suitable fabrics providing desired characteristics may be used other than those specifically described herein.

In this first preferred embodiment, the planters 12 may be filled with a plant growth media 18, such as coir pith material, compressed at an approximate ratio of 5:1, more or less into an approximate 10 pound block, which when hydrated with approximately 6 gallons of water will expand to approximately 2 to 2.5 cubic feet of plant growth media.

The container 20 contains a liquid-impervious hydration bag 32 containing a block 30 of dehydrated compressed media 18 of a size to fill two planters when hydrated and decompressed, two folded planters 12 and two spacers 16. Also, a bag containing two fertilizer packs may be included. If desired, the hydration bag 32 can be omitted and the block 30 later hydrated in any other suitable available container.

In a typical example of this first preferred embodiment, the container 20 is a cardboard shipping box 22 having a 12 inch square bottom and four sides 24, each side being side 12 inches wide and 8 inches high. As illustrated in FIG. 2 the contents are layered, starting at the bottom, as follows: a mesh spacer 16 (⅞ inches high), a folded planter 12 (⅜ inches high), another mesh spacer 16 (⅞ inches high), another folded planter 12 (⅜ inches high), a hydration bag 32 (⅜ inches high) and a block of dehydrated compressed (5-1) plant growth media 18 (5 inches high).

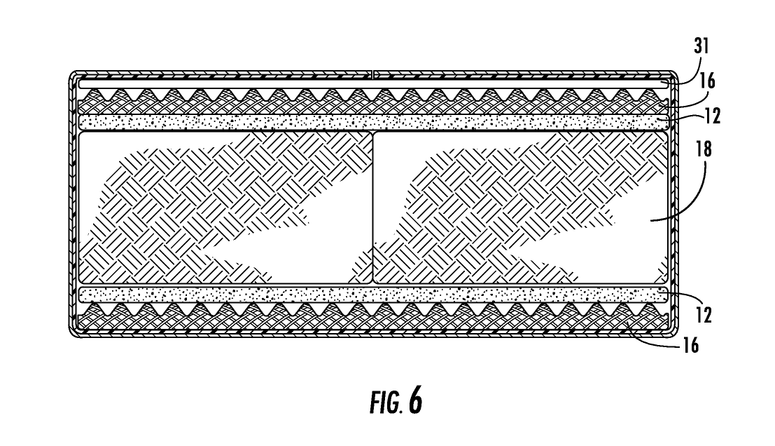

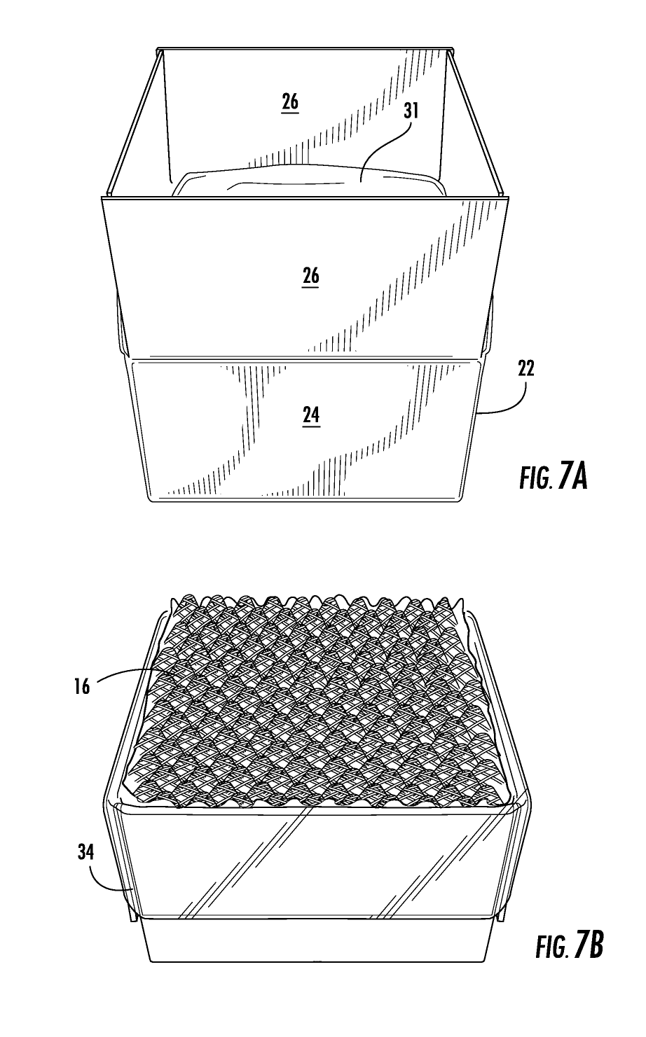

In an alternate preferred embodiment illustrated in FIGS. 5 and 6 of the container 20 there is one folded plastic liner 34 for lining the inside of the box 22 during hydrating of the compressed material in the planters. In the liner 34 there are two blocks 30 of compressed material, two folded planters 12, and two spacers 16.

While it is preferable that the mesh spacers 16 are included in the container, they could, if desired, be provided separately.

Preferably, the box 22 is of a height about the same as the combined height of two mesh spacers, two folded planters, two blocks of compressed material, and a hydration bag or a liner, and, when the top flaps 26 are upstanding, the total height is at least the same as the combined height of an unfolded open planter and one spacer.

In a typical example of this being alternate preferred embodiment, the container 20 is a cardboard shipping box 22 having a 12 inch square bottom and four sides 24, each side being 12 inches wide and 8 inches high. As illustrated in FIG. 6 the liner 30 extends around the inside of the box 22 and contains the components layered, starting at the bottom, as follows: a mesh spacer 16 (⅞ inches high), a folded planter 12 (⅜ inches high), a block of dehydrated compressed (5-1) plant growth media 18 (5 inches high), another folded planter 12 (⅜ inches high), another mesh spacer 16 (⅞ inches high), and two fertilizer packs 31 (⅜ inches high).

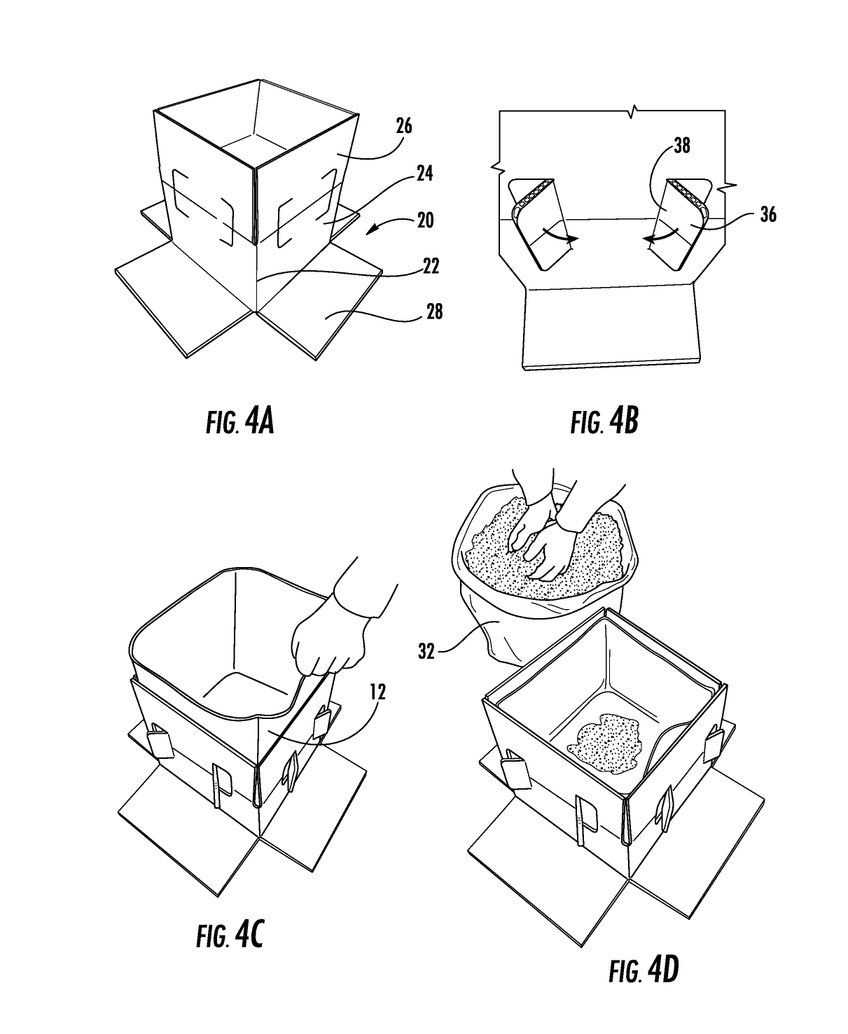

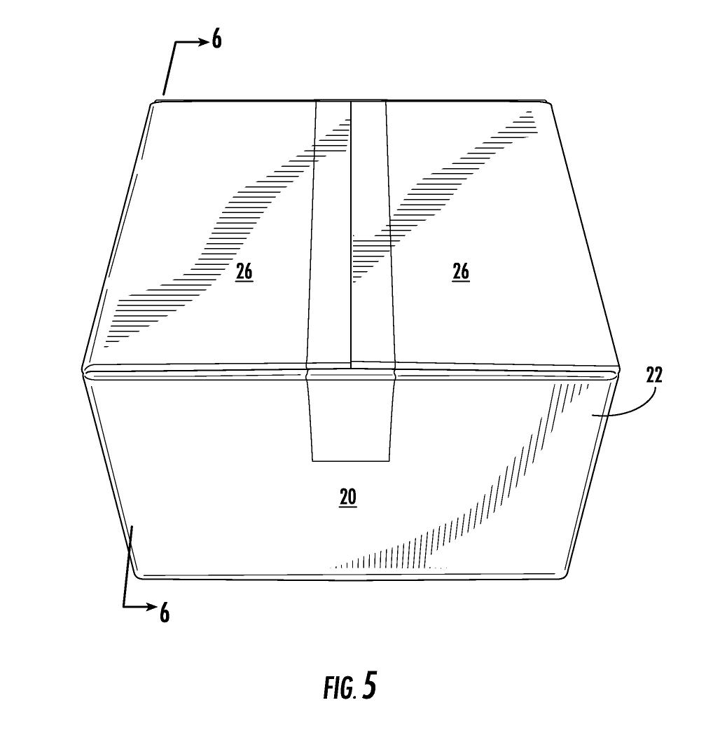

In practicing the first preferred method of the present invention using the container 20 described above, the first step is to unfold the top end closure flaps 26 of the box 22 to extend vertically. to open the top of the box. The contents are removed, The bottom end closure flaps 28 are unfolded to extend horizontally outwardly from the side walls for support of the box on a supporting surface in a standing position with the bottom of the box open (FIG. 4a). The top closure flaps 26 are maintained in the vertical position to maintain the top of the box open by punched out U-shaped tabs 36 (FIG. 4b) that extend from each side wall 24 into the adjacent top end closure flap 26 and have hinge lines 38 that extend into both the side wall 32 and the top flap 26. Before being punched out, the tabs fold with the top closure tabs, and, when the end closure flaps are unfolded to extend vertically and the U-shaped tabs are punched out, the tabs prevent folding of the end closure flaps from a vertical open disposition.

One of the mesh spacers 16 is then placed in the open bottom of the box 22. One of the planters 12 is unfolded and inserted in an upright position in the box 22 on top of the spacer 16 (FIG. 4c). The bag 36 is opened outside the box (FIG. 3a), the block 30 of compressed dehydrated plant growth media is placed in the bag 32, and water is added (FIG. 3b) and mixed to hydrate and decompress the plant growth media 18 to a volume sufficient to fill two planters (FIG. 3c). Enough hydrated plant growth media 18 is then transferred to the open planter 12 in the box 22 to fill the planter to a desired level and patted down by hand (FIG. 40, with the box serving as a form to maintain the filled planter in a square cross-section form. A block of fertilizer is then added (FIG. 4g).

The box 22 is then lifted from around the filled planter 12 (FIG. 4h), leaving the planter supported on the spacer 16. Then the planter and spacer can be slid to a desired location (FIG. 4i).

The procedure is repeated to fill the other planter and support it on the other spacer.

The height of the box 22 and the height of the planter 12 are correlated so that the box will provide a suitable form to support the unfolded planter while it is being filled with plant growth media 18.

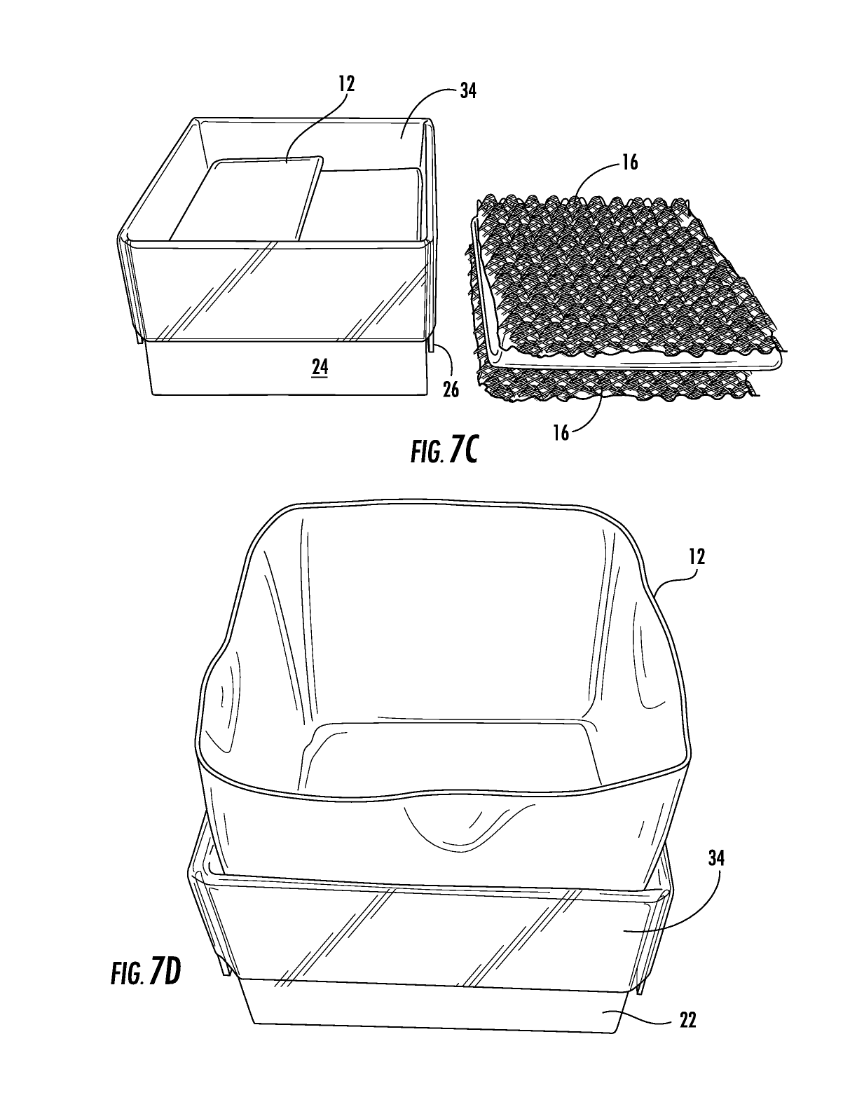

An alternative preferred embodiment of the method of the present invention using the second form of the container (FIGS. 5 and 6) results in the same filled planters 18 on spacers 16 that results with the embodiment described above. In this embodiment, the box 22 is opened by folding open the top end closure flaps 26 (FIG. 7a). The contents of the container are removed, with the plastic liner 34 open in the box. In opening the box the top end closure flaps 26 are folded open and down along the adjacent side wall and the top of the plastic liner is folded outwardly and downwardly over the opened top end flaps 26 to maintain the liner and the box open (FIG. 7b). The bottom end closure flaps 28 remain closed to maintain the bottom of the box closed.

One of the planters 12 is opened in the bottom of the open liner 34 (FIG. 7c) and one of the blocks 30 of dehydrated and compressed media is placed in the bottom of the planter 12 (FIG. 7d). Alternatively, the blocks of compressed media could be in the folded bags when packaged in the container. Water is then added into the planter 12 to hydrate and decompress the media 18 in the planter, with the box 22 serving as a form to retain the planter 12 in a square cross-section shape (FIG. 7e). The liner 34 resists liquid seeping through the planter during hydrating of the plant growth media, and, thereby, prohibits liquid from contacting the walls of the box.

The planter 12 filled with the hydrated plant growth media 18 is then lifted from the box 22 and placed on one of the spacers 16 outside the box 22 (FIG. 8). It is then slid to a desired location. The other planter 12 is then opened in the liner 34 in the box 22. The other block 30 of plant growth media is placed in the bottom of the liner 34 in the box 22. Water is then added to hydrate and decompress the plant growth media 18 in the planter 12. After the plant growth media 18 is hydrated and decompressed, the filled planter 12 is removed from the box 22 and placed on the other spacer 16 outside the box 22.

In view of the aforesaid written description of the present invention, it will be readily understood by those skilled in the art that the present invention is susceptible of broad utility and application in many embodiments and adaptations of the present invention other than those herein described. Many variations and modifications will be apparent from or reasonably suggested by the present invention and the foregoing description thereof without departing from the substance or scope of the present invention. Accordingly, while the present invention has been described herein in detail in relation to preferred embodiments, it is to be understood that this disclosure is only illustrative of examples of the present invention and is made merely for purposes of providing a full and enabling disclosure of the invention. The foregoing disclosure is not intended nor is it to be construed to limit the present invention or otherwise exclude any other embodiment, adaptations, variations, modifications and equivalent arrangements, the present invention being limited only by the scope of the claims appended hereto and equivalents thereof.

What is claimed is:

1. A container containing components for erecting an above-ground planter, said container comprising:
a closed container having a bottom wall, four sidewalls and a top wall, and containing:
at least one folded planter of a size to fill said container when said planter is unfolded;
at least one block of dehydrated and compressed plant growth media of a size sufficient to substantially fill said at least one planter when said at least one block of plant growth media is hydrated and decompressed.

2. A container according to claim 1 and characterized further in that said container contains at least one mesh spacer for supporting a planter on a supporting surface after said planter has been filled with hydrated and decompressed plant growth media and removed from said container.

3. A container according to claim 1 and characterized further in that said container contains a folded bag of liquid-impervious material of a size when unfolded to retain said lock of plant growth media during hydrating and decompressing of said plant growth media.

4. A container according to claim 2 and characterized further in that said container contains two said blocks of dehydrated and compressed plant growth media, and two said mesh spacers.

5. A container according to claim 1 and characterized further in that said container has bottom closure flaps openable to form an open container bottom to permit removal of said container from an unfolded planter in said container after it has been filled with hydrated and decompressed plant growth media.

6. A container according to claim 1 and characterized further in that said container has openable top closure flaps foldable from said sidewalls, and U-shaped punch-out tabs in said sidewalls and extending into adjacent top closure flaps for preventing folding of said top closure flaps from a vertical open position when said tabs are in a punched out position.

7. A method of erecting and filling an above-ground planter with components contained in a container that has side walls and bottom closure flaps, the components include a planter folded to fit in the container, said planter having an unfolded shape that fits the inside of said container, and a block of dehydrated and compressed plant growth media shaped to fit in the container and being of sufficient volume when hydrated and decompressed to substantially fill the unfolded planter, comprising:
opening the container and removing said components from said container;
folding the bottom closure flaps of said container to open the bottom of said container, and placing said bottom open container on a supporting surface with said bottom closure flaps extending outwardly from the open bottom of said container;
unfolding said planter and placing it in said open container;
hydrating and decompressing said plant growth media by adding water to said media;
filling said unfolded planter with said hydrated and decompressed plant growth media, while using said container as a form for retaining the filled planter in the shape of the container during and after filling of the planter; and
lifting said container from said filled planter.

8. A method of erecting and filling an above-ground planter according to claim 7, and characterized further in that there is a mesh spacer included in said container, which spacer is of a size to fit inside said planter, wherein said spacer is placed in the open bottom of said container before said unfolded planter is placed in the container on said spacer, with said filled planter being on said spacer when said container is lifted from said filled planter.

9. A method of erecting and filling an above-ground planter according to claim 7, and characterized further in that there is a folded liquid-impervious bag included in said container, said bag being of a size to contain said hydrated and decompressed plant growth media, wherein said dehydrated and compressed plant growth media is placed in said bag and is hydrated and decompressed in said bag before being filled into said planter.

10. A method of erecting and filling an above-ground planter according to claim 7, and characterized further in that said container has top closure flaps and a U-shaped punch-out tab in each side wall and extending into the adjacent top closure flap, wherein said tabs are punched out from a position foldable with said top closure flaps to a punched out position preventing folding of said top closure flaps from vertical open disposition.

11. A method of erecting and filling an above-ground planter according to claim 7, and characterized further in that there is a block of fertilizer in said container, wherein said block of fertilizer is added to said decompressed and hydrated plant growth media prior to filling said unfolded planter with said plant growth media.

12. A method of erecting and filling an above-ground planter according to claim 7, and characterized further in that there are at least two folded planters, and said block of hydrated and compressed plant growth media is of sufficient volume when hydrated and decompressed to fill each of said planters, wherein each of said planters are filled in the method recited in claim 7.

13. A method of erecting and filling an above-ground planter with components contained in a container that has side walls and a bottom wall, the components include a liquid-impervious liner of a size to line the inside of the container, a planter folded to fit in the container, said planter having an unfolded shape that fits the inside of said container, and a block of dehydrated and compressed plant growth media shaped to fit in the container and being of sufficient volume when hydrated and decompressed to substantially fill the unfolded planter, comprising:
removing said components from said container with said liner lining the inside of said container;
unfolding said planter and placing it in said container within said liner;
placing said block of dehydrated and compressed plant growth media in said unfolded planter;
hydrating and decompressing said plant growth media by adding water to said media to fill said planter with plant growth media while using said container as a form for retaining the filled planter in the shape of the container during and after filling of the plant; and
lifting said filled planter from said container.

14. A method of erecting and filling an above-ground planter according to claim 13, and characterized further in that said container contains at least two of said folded planters, and at least two blocks of said dehydrated and compressed plant growth media, wherein after one planter is filled and lifted from said container, another unfolded planter is placed in said liner within said container and filled with plant growth media according to claim 13.

15. A method of erecting and filling an above-ground planter according to claim 13, and characterized further in that there is a mesh spacer included in said container, which spacer is of a size to fit inside said planter, wherein said spacer is removed from said container with the other said components, and in lifting said filled planter from said container it is placed on said mesh spacer.

16. A method of erecting and filling an above-ground planter according to claim 14, and characterized further in that said container contains at least two of said folded planters, at least two blocks of said dehydrated and compressed plant growth media, and at least two of said mesh spacers, wherein after one planter will is filled and lifted from said container onto one of said mesh spacers, another of said unfolded planters is placed in said liner within said container and filled with plant growth media, and lifted from said container and placed on another of said mesh spacers.

17. A method of erecting and filling an above-ground planter according to claim 13, and characterized further in that there is a block of fertilizer in said container, wherein said block of fertilizer is added to said decompressed and hydrated plant growth media in said planter prior to lifting said filled planter from said container.

18. A method of erecting and filling an above-ground planter according to claim 13, and characterized further in that said container has top closure flaps and said liner extends beyond said container when said container is open, wherein said container is opened for removal of said components by folding said top closure flaps outwardly along the sides of said container, after which said liner is folded down over said top closure flaps to retain the container open.

19. An above-ground planting bed comprising at least two planters filled with plant growth media, said planters having substantially flat sides of air and moisture permeable material with a side of each said planter being contiguous with a side of another of said planters to allow expansion of root systems from one planter into an adjacent planter.

20. An above-ground planting bed according to claim 19, characterized further in that there are a plurality of said adjacent planters arranged in a composite configuration.
